(19) United States
(12) Patent Application Publication
(10) Pub. No.: US 2015/0170597 A1
(43) Pub. Date: Jun. 18, 2015

(54) LIQUID CRYSTAL DISPLAY DEVICE AND METHOD OF DRIVING THE SAME

(71) Applicant: Samsung Display Co., Ltd., Yongin-City (KR)

(72) Inventor: Yong Hwan Shin, Yongin-si (KR)

(73) Assignee: Samsung Display Co., Ltd., Yongin-City (KR)

(21) Appl. No.: 14/289,509

(22) Filed: May 28, 2014

(30) Foreign Application Priority Data
Dec. 17, 2013 (KR) 10-2013-0157182

(51) Int. Cl. G09G 3/36

(52) U.S. Cl. CPC G09G 3/3696; G09G 3/3685; G09G 3/3674; G09G 2320/028; G09G 2330/023

(57) ABSTRACT

A liquid crystal display (LCD) device and methods of driving the same are disclosed. One inventive aspect comprises a display panel, a scan driver and a data driver. The data driver provides a first data voltage and a second data voltage to the display panel during a unit frame. The first and second data voltages are provided during a first subframe and a second subframe of a unit frame, respectively. Further, a ratio of a period of the first subframe to a period of the second subframe is greater or less than 1.

### CROSS-REFERENCE TO RELATED APPLICATIONS

This application claims priority from Korean Patent Application No. 10-2013-0157182 filed on Dec. 17, 2013 in the Korean Intellectual Property Office, the disclosure of which is incorporated herein by reference in its entirety.

### BACKGROUND

1. Field

The described technology generally relates to a liquid crystal display (LCD) device and a method of driving the same with improved lateral visibility and reduced power consumption.

2. Description of the Related Technology

Liquid crystal displays (LCDs) are one of the most popular types of flat panel displays. Generally, an LCD includes a pair of display panels of electric field generating electrodes, such as pixel electrodes and a common electrode, and a liquid crystal layer interposed between the display panels. In an LCD, voltages are applied to electric field generating electrodes to generate an electric field. Accordingly, the alignment of liquid crystal molecules of a liquid crystal layer and polarization of incident light are controlled. As a result, a desired image can be displayed on the LCD.

A LCD also includes a switching element connected to each of the pixel electrodes and a plurality of signal lines (such as gate lines and data lines) for applying voltages to the pixel electrodes by controlling the switching elements.

Such an LCD has a narrow viewing angle due to anisotropy of liquid crystals. Because the optical phase retardation of the liquid crystals varies according to viewing angles, light transmittance characteristics at the front are different than those at the sides. This results in a difference between front visibility characteristics and lateral visibility characteristics.

### SUMMARY OF CERTAIN INVENTIVE ASPECTS

One inventive aspect of the disclosed technology is a liquid crystal display (LCD) having improved lateral visibility.

Another inventive aspect of the disclosed technology is a method of driving an LCD having improved lateral visibility.

However, aspects of the disclosed technology are not restricted to the one set forth herein. The above and other aspects of the disclosed technology will become more apparent to one of ordinary skill in the art to which the disclosed technology pertains by referencing the detailed description of the disclosed technology given below.

According to one inventive aspect of the disclosed technology, there is provided A liquid crystal display (LCD) comprising a display panel which includes a plurality of display surfaces, a scan driver which provides a scan signal to each of the display surfaces and a data driver which provides a first data voltage and a second data voltage different from the first data voltage to the display panel during a unit frame, wherein the unit frame comprises a first subframe during which the first data voltage is provided and a second subframe during which the second data voltage is provided, and a ratio of a period of the first subframe and a period of the second subframe is uneven.

The display panel comprises first through n-th display surfaces, the scan driver comprises first through n-th scan driving units which sequentially transmit the scan signals to the first through n-th display surfaces, respectively, and a ratio of the period of the second subframe to the period of the first subframe is about 2n−1, where n is an integer greater than one.

Each of the display surfaces comprises a plurality of scan lines, a plurality of data lines intersecting the scan lines, and a plurality of pixels, each connected to one of the scan lines and one of the data lines, and the first through n-th scan driving units transmit the scan signals to the scan lines, respectively.

An image to be displayed on the display panel is provided as a combination of the first data voltage and the second data voltage.

The first data voltage has a value equal to or greater than approximately 120% of a luminance level displayed on the display panel, and the second data voltage has a value equal to or less than approximately 80% of the luminance level.

The LCD can further comprise a data generator which corrects received image data such that the image data corresponds to the period of the first subframe and the period of the second subframe.

The LCD can further comprise a gamma voltage generator which generates different gamma reference voltages.

The refresh frequency of the unit frame is substantially 60 Hz.

The display panel comprises a first display surface and a second display surface, the scan driver comprises a first scan driving unit and a second scan driving unit which transmit the scan signals to the first display surface and the second display surface, respectively, and a ratio of the period of the second subframe to the period of the first subframe is three.

Each of the first display surface and the second display surface independently receives the first data voltage and the second data voltage in a time ratio of about 1:3.

According to another inventive aspect of the disclosed technology, there is provided An LCD comprising a display panel which includes a plurality of display surfaces, a scan driver which provides a scan signal to each of the display surfaces and a data driver which sequentially provides a first data voltage and a second data voltage different from the first data voltage to the display panel during a unit frame, wherein a period of time during which the second data voltage is provided to some of the display surfaces of the display panel to a period of time during which the first data voltage is provided to the some of the display surfaces is about 2 to 2.5, and a period of time during which the second data voltage is provided to the other display surfaces of the display panel to a period of time during which the first data voltage is provided to the other display surfaces is about 1.7 to 2.1.

In one implementation, a ratio of a period of time during which the second data voltage is provided to six sevenths of the entire area of the display surfaces to a period of time during which the first data voltage is provided to the six sevenths of the entire area is 2.5, and a ratio of a period of time during which the second data voltage is provided to one sevenths of the entire area of the display surfaces to a period of time during which the first data voltage is provided to the one sevenths of the entire area is about 2.1

In another implementation, a ratio of a period of time during which the second data voltage is provided to two thirds of the entire area of the display surfaces to a period of time during which the first data voltage is provided to the two thirds of the entire area is 2, and a ratio of a period of time during which the second data voltage is provided to one third of the entire area of the display surfaces to a period of time during which the first data voltage is provided to the one third of the entire area is about 1.7.

In yet another implementation, an image to be displayed on the display panel is provided as a combination of the first data voltage and the second data voltage.

In some other implementation, the first data voltage has a value equal to or greater than approximately 120% of a luminance level displayed on the display panel, and the second data voltage has a value equal to or less than approximately 80% of the luminance level.

According to another inventive aspect of the disclosed technology, there is provided a method of driving an LCD, the method comprising transmitting a scan signal to each of a plurality of display surfaces of a display panel and transmitting a data voltage according to the scan signal, wherein a first data voltage and a second data voltage included in the data voltage are applied sequentially during a unit frame, the unit frame comprises a first subframe during which the first data voltage is provided and a second subframe during which the second data voltage is provided, and a ratio of a period of the first subframe and a period of the second subframe is uneven.

In one implementation, the display panel comprises first through n-th display surfaces, a scan driver comprises first through n-th scan driving units which sequentially transmit the scan signals to the first through n-th display surfaces, respectively, and a ratio of the period of the second subframe to the period of the first subframe is about 2n−1, where n is an integer greater than one.

In another implementation, each of the display surfaces comprises a plurality of scan lines, a plurality of data lines intersecting the scan lines, and a plurality of pixels, each connected to one of the scan lines and one of the data lines, and the first through n-th scan driving units transmit the scan signals to the scan lines, respectively.

In some implementations, an image to be displayed on the display panel is provided as a combination of the first data voltage and the second data voltage.

In some other implementations, the first data voltage has a value equal to or greater than approximately 120% of a luminance level displayed on the display panel, and the second data voltage has a value equal to or less than approximately 80% of the luminance level.

### BRIEF DESCRIPTION OF THE DRAWINGS

The above and other aspects and features of the disclosed technology will become more apparent by describing in detail exemplary embodiments thereof with reference to the attached drawings, in which:

FIG. 1 is a block diagram of a liquid crystal display (LCD) according to an embodiment of the disclosed technology;

FIG. 2 is a block diagram of a first display surface illustrated in FIG. 1;

FIG. 3 is a diagram illustrating the relationship between a first data voltage and a second data voltage;

FIGS. 4 through 6 are diagrams illustrating the divided driving of the LCD;

FIG. 7 is a block diagram of a timing controller illustrated in FIG. 1;

FIG. 8 is a block diagram of a memory illustrated in FIG. 7;

FIG. 9 is a block diagram of an LCD according to another embodiment of the disclosed technology;

FIG. 10 is a block diagram of an LCD according to another embodiment of the disclosed technology;

FIGS. 11 through 14 are diagrams illustrating the divided driving of the LCD; and

FIG. 15 is a flowchart illustrating a method of driving an LCD according to an embodiment of the disclosed technology.

### DETAILED DESCRIPTION OF CERTAIN INVENTIVE EMBODIMENTS

The aspects and features of the disclosed technology and methods for achieving the aspects and features will be apparent by referring to the embodiments to be described in detail with reference to the accompanying drawings. However, the disclosed technology is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the disclosed technology is only defined within the scope of the appended claims.

In the following description, technical terms are used only to explain a specific exemplary embodiment while not limiting the disclosed technology. The terms of a singular form may include plural forms unless referred to the contrary. The terms “include,” “comprise,” “including,” and “comprising,” as used herein, specify a component, a process, an operation, and/or an element but do not exclude other components, processes, operations, and/or elements. It will be understood that although the terms “first” and “second” are used herein to describe various elements, these elements should not be limited by these terms. These terms are only used to distinguish one component from other components.

It will be understood that when a layer, region, or component is referred to as being “formed on,” another layer, region, or component, it can be directly or indirectly formed on the other layer, region, or component. That is, for example, intervening layers, regions, or components may be present.

The drawings and description are to be regarded as illustrative in nature and not restrictive. Like reference numerals designate like elements throughout the specification.

Further, since sizes and thicknesses of constituent members shown in the accompanying drawings are arbitrarily given for better understanding and ease of description, the disclosed technology is not limited to the illustrated sizes and thicknesses.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it is directly on the other element or intervening elements may also be present.

Throughout this specification and the claims that follow, when it is described that an element is “connected” to another element, the element is “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements. Throughout this specification, it is understood that the term “on” and similar terms are used generally and are not necessarily related to a gravitational reference.

Here, when a first element is described as being connected to a second element, the first element is not only directly connected to the second element but may also be indirectly connected to the second element via a third element. Further, some of the elements that are not essential to the complete understanding of the disclosed technology are omitted for clarity. Also, like reference numerals refer to like elements throughout.

Hereinafter, embodiments of the disclosed technology will be described with reference to the attached drawings.

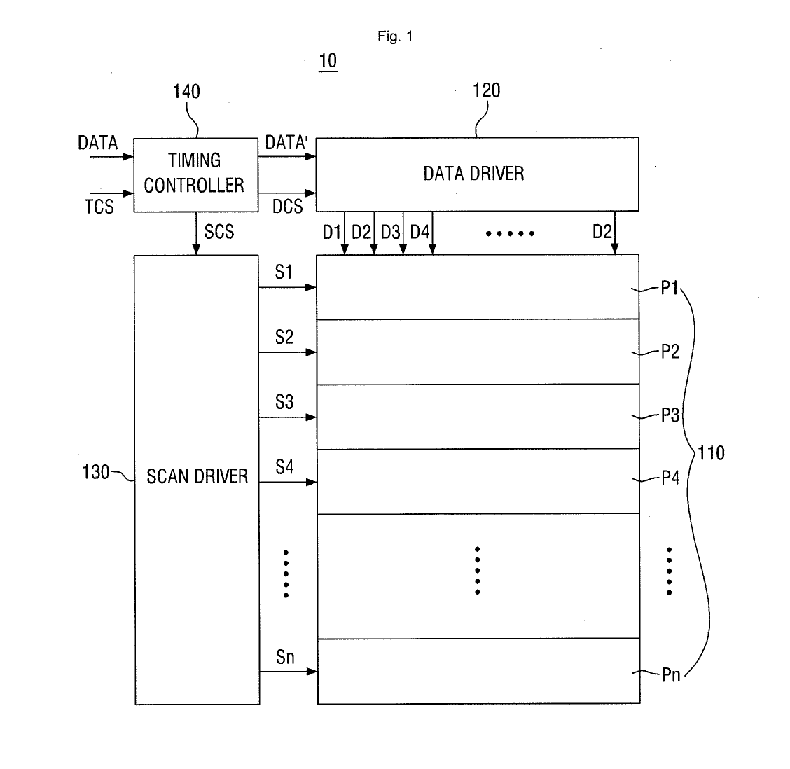

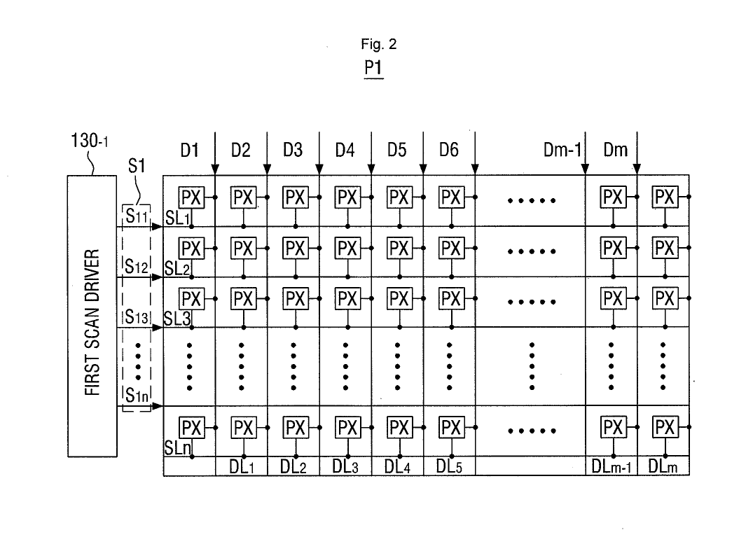

FIG. 1 is a block diagram of a liquid crystal display (LCD) 10 according to an embodiment of the disclosed technology. FIG. 2 is a block diagram of a display surface illustrated in FIG. 1. Referring to FIG. 1, the LCD 10 includes a display panel 110, a data driver 120, and a scan driver 130.

Various types of display panels can be used as the display panel 110 according to a method of displaying an image. In one exemplary implementation, the display panel 110 is, but is not limited to, one of an LCD panel, an organic light-emitting diode (OLED) display panel, a plasma display panel, or an electrophoretic display panel. The display panel 110 includes a plurality of display surfaces P1 through Pn. The display surfaces P1 through Pn may not display independent images individually. Instead, the whole image displayed on the display panel 110 may be divided according to the area of each of the display surfaces P1 through Pn. However, the display surfaces P1 through Pn may individually receive independent scan signals S1 through Sn from the scan driver 130.

The scan driver 130 generates the scan signals S1 through Sn and provides the scan signals S1 through Sn to the display surfaces P1 through Pn, respectively. The scan driver 130 sequentially transmits the scan signals S1 through Sn. In one exemplary implementation, the scan driver 130 transmits the first scan signal S1 to the first display surface P1 and then transmits the second scan signal S2 to the second display surface P2. The display surfaces P1 through Pn receives data voltages from the data driver 120 according to the scan signals S1 through Sn.

Referring to FIG. 2, each of the display surfaces P1 through Pn includes a plurality of scan lines SL1 through SLn, a plurality of data lines DL1 through DLm intersecting the scan lines SL1 through SLn, and a plurality of pixels PX. Each of the pixels PX is connected to one of the scan lines SL1 through SLn and one of the data lines DL1 through DLm. The scan lines SL1 through SLn may extend in one direction. The scan lines SL1 through SLn may be substantially parallel to each other. The scan lines SL1 through SLn may include first through n^{th} scan lines SL1 through SLn arranged sequentially. Scan signals S11 through S1n are transmitted to the scan lines SL1 through SLn. The data lines DL1 through DLm may include first through m^{th} data lines DL1 through DLm arranged sequentially. The data lines DL1 through DLm may intersect the scan lines SL1 through SLn, respectively. The data lines DL1 through DLm may extend in a direction different than the direction in which the scan lines SL1 through SLn extend. In addition, the data lines DL1 through DLm may be substantially parallel to each other. Data voltages D1 through Dm are applied to the data lines DL1 through DLm. The pixels PX may be arranged in a matrix, but the arrangement pattern of the pixels PX is not limited to the matrix pattern. Each of the pixels PX is connected to one of the scan lines SL1 through SLn and one of the data lines DL1 through DLm. Each of the pixels PX may receive a data voltage applied to a connected data line according to a scan signal received from a connected scan line. The scan signals S1 through Sn may include a scan-on signal Son and a scan-off signal Soff. When receiving the scan-on signal Son, each of the pixels PX may receive a data voltage applied to a data line connected thereto. When receiving the scan-off voltage Soff, each of the pixels PX may not receive a data voltage. Each of the pixels PX may display a gray level corresponding to a received data voltage.

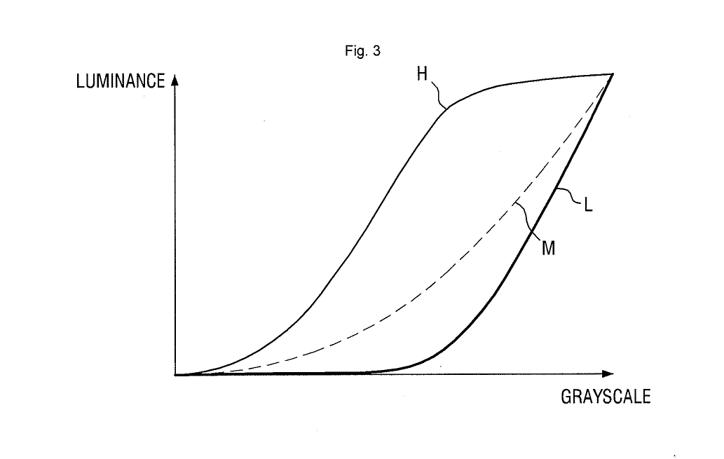

Each of the data voltages D1 through Dm includes a first data voltage H and a second data voltage L. The second data voltage L is different than the first data voltage H. In one exemplary implementation, the data driver 130 provides the first data voltage H and the second data voltage L to each of the pixels PX during a unit frame. This will be described in greater detail with reference to FIG. 3.

FIG. 3 is a diagram illustrating the relationship between the first data voltage H and the second data voltage L. Referring to FIG. 3, an image to be displayed on the display panel 110 is provided as a combination of the first data voltage H and the second data voltage L. The first data voltage H is a high-luminance data voltage, and the second data voltage L is a low-luminance data voltage. In one exemplary implementation, the first data voltage H has, but not limited to, a value equal to or greater than approximately 120% of a luminance level displayed on the display panel 110. The second data voltage L has, but not limited to, a value equal to or less than approximately 80% of the luminance level. Pixels having high luminance and pixels having low luminance can provide high viewing-angle characteristics and good lateral visibility. In some exemplary implementations, since the LCD 10 displays an image by applying the first data voltage H having high luminance and the second data voltage L having low luminance to the display panel 110 during a unit frame, the lateral visibility of the LCD 10 can be improved.

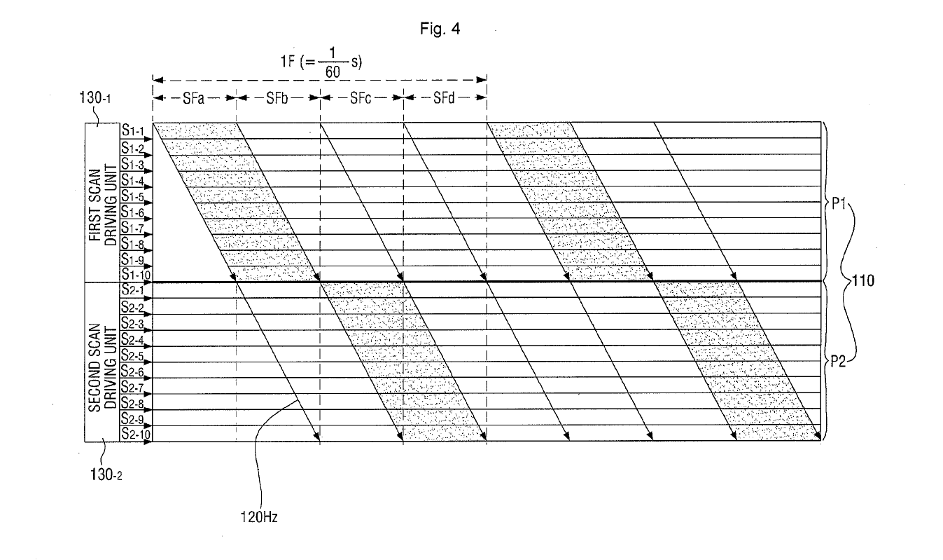

Here, the first data voltage H may be provided to the display panel 110 during a first subframe SF1. The second data voltage L may be provided to the display panel 110 during a second subframe SF2. The first subframe SF1 and the second subframe SF2 may be included in one unit frame F1. In some exemplary implementations, the first data voltage H and the second data voltage L are provided at different times. The first subframe SF1 may be followed by the second subframe SF2. When the first subframe SF1 and the second subframe SF2 are provided for different periods of time, the viewing angle can be improved more. In some other exemplary implementations, a ratio of the period of the first subframe SF1 and the period of the second subframe SF2 is greater or less than 1. The period of the second subframe SF2 may be, but is not limited to, longer than the period of the first subframe SF1. To divide a unit frame into a plurality of subframes as described above, the display panel 110 may need to be driven at a high-speed frequency. However, the LCD 10 according to the current embodiment can provide the same effect as the display panel 110 is driven at a high-speed frequency by dividing the display panel 110 into a plurality of display surfaces and driving the display surfaces individually at about 120 Hz or 60 Hz, not at a high-speed frequency. In some exemplary implementations, when the display panel 110 is divided into first through n^{th} display surfaces, a ratio of the period of the second subframe SF2 to the period of the first subframe SF1 is substantially 2n−1, where n is an integer greater than one. This will now be described in greater detail with reference to FIGS. 4 through 6.

FIGS. 4 through 6 are diagrams illustrating the divided driving of the LCD 10.

Referring to FIG. 4, the display panel 110 is divided into a first display surface P1 and a second display surface P2. The scan driver 130 may include a first scan driving unit 130_1 which transmits scan signals S1_1 through S1_10 to the first display surface P1 and a second scan driving unit 130_2 which transmits scan signals S2_1 through S2_10 to the second display surface P2. The number of pixels PX included in the first display surface P1 and the number of the scan signals S1_1 through S1_10 transmitted to the pixels PX are not limited to the exemplary illustrated in FIG. 4. The first scan driving unit 130_1 and the second scan driving unit 130_2 may provide scan signals to the first display surface P1 and the second display surface P2, respectively. The first scan driving unit 130_1 may sequentially provide the first through tenth signal S1_1 through S1_10 to the first display surface P1, and the second scan driving unit 130_2 may sequentially provide the first through tenth signals S2_1 through S2_10 to the second display surface P2. Here, after the first scan driving unit 130_1 provides the tenth signal S1_10, the second scan driving unit 130_2 may provide the first signal S2_1, but the disclosed technology is not limited thereto. The refresh frequency of a unit frame of the display panel 110 may be about 60 Hz. Therefore, a scan signal having a frequency of 120 Hz is provided twice to the entire display panel 110 and four times to the first display surface P1 and the second display surface P2. In some exemplary implementations, each of the first display surface P1 and the second display surface P2 are divided into four subframes. As illustrated in FIG. 4, the first data voltage H is applied to an a^{th} subframe SFa of the first display surface P1. The second data voltage L is applied to the other subframes SFb, SFc and SFd. In addition, the first data voltage H is be applied to a b^{th} subframe SFb of the second display surface P2. The second data voltage L is applied to the other subframes SFa, SFc and SFd. In some exemplary implementations, each of the first display surface P1 and the second display surface P2 independently receives the first data voltage H and the second data voltage L in a time ratio of substantially 1:3. Since the LCD 10 according to the current embodiment divides the display panel 110 into two display surfaces and drive the two display surfaces individually, it can provide four subframes even at a driving frequency of about 60 Hz. Furthermore, since the LCD 10 according to the current embodiment can provide a high-luminance voltage and a low-luminance voltage in a time ratio of substantially 1:3, it cannot only improve lateral viewing angle but also reduce power loss.

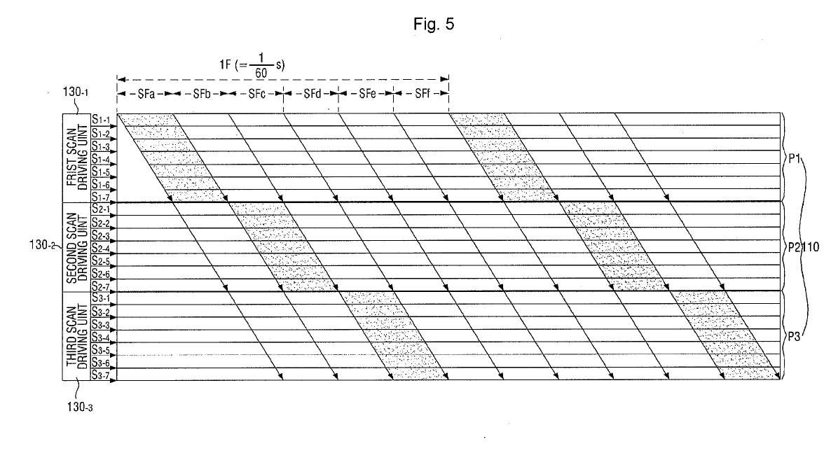

Referring to FIG. 5, the display panel 110 is divided into a first display surface P1, a second display surface P2, and a third display surface P3. The scan driver 130 may include a first scan driving unit 130_1 which transmits scan signals through S1_7 to the first display surface P1, a second scan driving unit 130_2 which transmits scan signals S2_1 through S2_7 to the second display surface P2, and a third scan driving unit 130_3 which transmits scan signals S3_1 through S3_7 to the third display surface P3. The number of pixels PX included in the first display surface P1 and the number of the scan signals S1_1 through S1_7 transmitted to the pixels PX are not limited to the exemplary illustrated in FIG. 5. The first scan driving unit 130_1, the second scan driving unit 1302, and the third scan driving unit 130_3 may provide scan signals to the first display surface P1, the second display surface P2, and the third display surface P3, respectively. The refreshing frequency of a unit frame of the display panel 110 may be about 60 Hz. Therefore, a scan signal having a frequency of 120 Hz, which is twice to the entire display panel 110 and six times to the first display surface P1, the second display surface P2, and the third display surface P3, is provided. In some exemplary implementations, each of the first display surface P1, the second display surface P2, and the third display surface P3 is divided into six subframes. As illustrated in FIG. 5, the first data voltage H is applied to an a^{th} subframe SFa of the first display surface P1. The second data voltage L is applied to the other subframes SFb through SRf. In addition, the first data voltage H may be applied to a b^{th} subframe SFb of the second display surface P2, and the second data voltage L may be applied to the other subframes SFa and SFc through SFf. In some exemplary implementations, each of the first display surface P1, the second display surface P2, and the third display surface P3 independently receives the first data voltage H and the second data voltage L in a time ratio of substantially 1:5. In some exemplary implementations, because the LCD 10 divides the display panel 110 into three display surfaces and drive the three display surfaces individually, it can provide six subframes even at a driving frequency of about 60 Hz. Furthermore, in some other implementations, because the LCD 10 provides a high-luminance voltage and a low-luminance voltage in a time ratio of substantially 1:5, it cannot only improve lateral viewing angle but also reduce power loss.

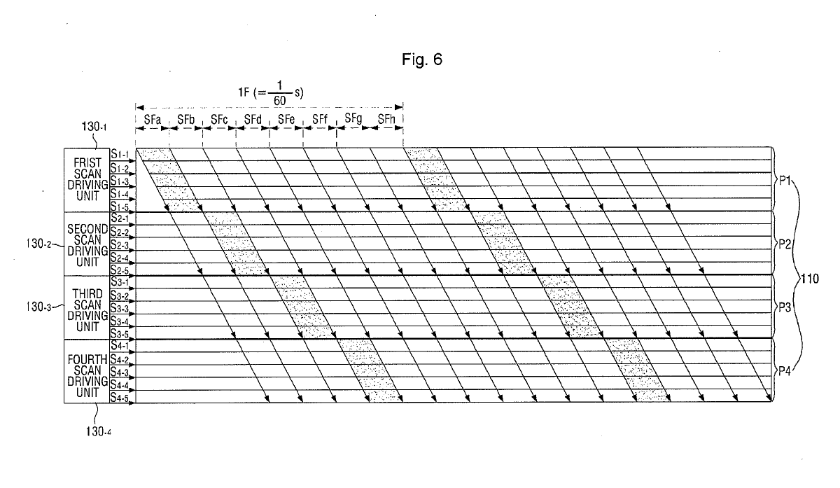

Referring to FIG. 6, the display panel 110 is divided into a first display surface P1, a second display surface P2, a third display surface P3, and a fourth display surface P4. The scan driver 130 may include a first scan driving unit 130_1 which transmits scan signals S1_1 through S15 to the first display surface P1, a second scan driving unit 130_2 which transmits scan signals S2_1 through S2_5 to the second display surface P2, a third scan driving unit 130_3 which transmits scan signals S3_1 through S3_5 to the third display surface P3, a fourth scan driving unit 130_4 which transmits scan signals S4_1 through S4_5 to the fourth display surface P4. The number of pixels PX included in the first display surface P1 and the number of the scan signals S1_1 through S1_5 transmitted to the pixels PX are not limited to the exemplary illustrated in FIG. 6. The first scan driving unit 130_1, the second scan driving unit 130_2, the third scan driving unit 130_3, and the fourth scan driving unit 130_4 may provide scan signals to the first display surface P1, the second display surface P2, the third display surface P3, and the fourth display surface P4, respectively. A unit frame of the display panel 110 may be 60 Hz. Therefore, a scan signal having a frequency of 120 Hz, which is twice to the entire display panel 110 and eight times to the first display surface P1, the second display surface P2, the third display surface P3, and the fourth display surface P4, is provided. In one exemplary implementation, each of the first display surface P1, the second display surface P2, the third display surface P3, and the fourth display surface P4 is divided into eight subframes. As illustrated in FIG. 6, the first data voltage H is applied to an a^{th} subframe SFa of the first display surface P1, and the second data voltage L may be applied to the other subframes SFb through SFh. In addition, the first data voltage H may be applied to a b^{th} subframe SFb of the second display surface P2, and the second data voltage L may be applied to the other subframes SFa and SFc through SFh. In another exemplary implementation, each of the first display surface P1, the second display surface P2, the third display surface P3, and the fourth display surface P4 independently receives the first data voltage H and the second data voltage L in a time ratio of about 1:7. In some exemplary implementations, because the LCD 10 divides the display panel 110 into four display surfaces and drive the four display surfaces individually, it can provide eight subframes even at a driving frequency of about 60 Hz. Furthermore, since the LCD 10 according to the current embodiment can provide a high-luminance voltage and a low-luminance voltage in a time ratio of about 1:7, it cannot only improve lateral viewing angle but also reduce power loss.

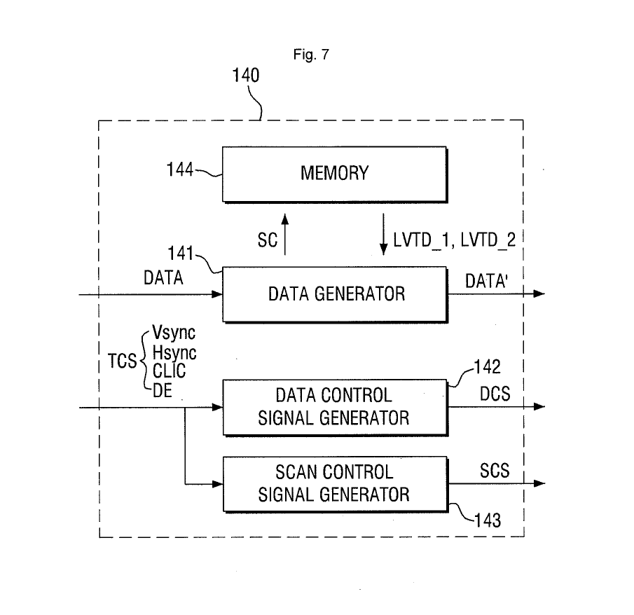

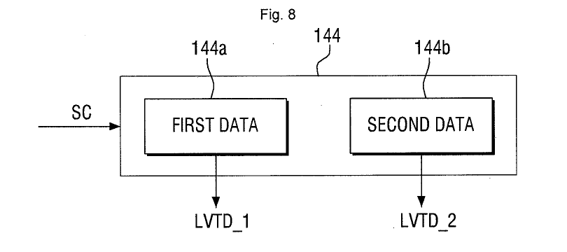

Referring back to FIG. 1, the LCD 10 according to the current embodiment further includes a timing controller 140. The timing controller 140 may receive image data DATA and a control signal TCS and generate a control signal SCS, a data driver control signal DCS, and corrected image data DATA′ based on the image data DATA and the control signal TCS. The scan driver control signal SCS may be provided to the scan driver 130 so as to control the scan driver 130 and may include a vertical synchronization signal. The data driver control signal DCS may be provided to the data driver 120 so as to control the data driver 120 and may include a horizontal synchronization signal. The corrected image data DATA′ may be provided to the data driver 120. The timing controller 140 may include a data generator 141. However, the disclosed technology is not limited thereto. In some embodiments, the data generator 141 is provided separately from the timing controller 140. The timing controller 140 will be described in greater detail with reference to FIGS. 7 and 8.

FIG. 7 is a block diagram of the timing controller 140 of FIG. 1, and FIG. 8 is a block diagram of a memory 144 of FIG. 7.

Referring to FIG. 7, the timing controller 140 includes the data generator 141, a data control signal generator 142, a scan control signal generator 143, and the memory 144. The data generator 141 may receive the image data DATA from an external source and correct the image data DATA such that the image data DATA corresponds to a first subframe period and a second subframe period. In some exemplary implementations, the image data DATA are corrected such that the first data voltage H is applied during the first subframe period and that the second data voltage L is applied during the second subframe period. The data generator 141 may read out correction data needed to correct the image data DATA from the memory 144. The memory 144 may include a first data lookup table 144a and a second data lookup table 144b. The memory 144 provides first correction data LUTD_1 and second correction data LUTD_2 at least according to a selection signal SC received from the data generator 141. The data generator 141 may correct the image data DATA based on the first and second correction data LUTD_1 and LUTD_2 and output the corrected data DATA′ to the data driver 120.

The data control signal generator 142 and the scan control signal generator 143 receives the control signal TCS from an external source. The control signal TCS may include a vertical synchronization signal Vsync, a horizontal synchronization signal Hsync, a data enable signal DE, and a clock signal CLK.

The data control signal generator 142 generates the data driver control signal DCS for controlling the data driver 120 at least in response to the control signal TCS. The data control signal generator 142 outputs the data driver control signal DCS to the data driver 120. The data driver control signal DCS may include, e.g., a source start pulse (SSP), a source sampling clock (SSC), a source output enable (SOE) signal, and a polarity (POL) signal.

The scan control signal generator 143 generates the gate driver control signal GCS for controlling the gate driver 130 in response to the control signal TCS. The scan control signal generator 143 outputs the gate driver control signal GCS to the gate driver 130. The gate driver control signal GCS may cause scan signals to be generated sequentially. In particular, the gate driver control signal GCS may control the scan driving units 130_1 through 130_{—}n to independently scan the display surfaces P1 through Pn, respectively.

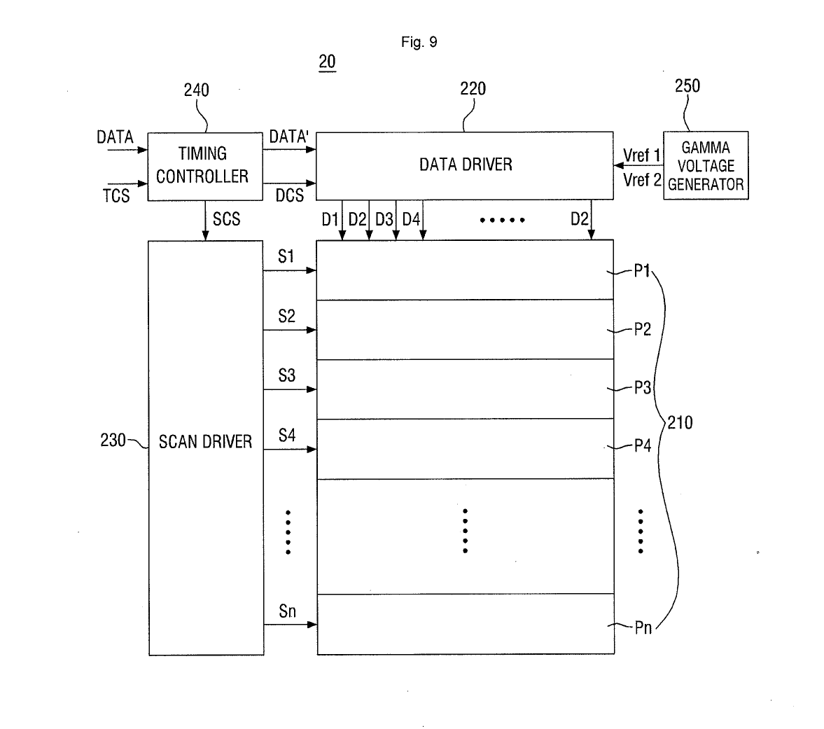

An LCD according to another embodiment of the disclosed technology will now be described with reference to FIG. 9.

An LCD 20 according to another embodiment of the disclosed technology further includes a gamma voltage generator 250 which generates different gamma reference voltages.

Unlike the timing controller 140 of the previous embodiment, a timing controller 240 of the LCD 20 according to the current embodiment may not perform data correction. The gamma voltage generator 250 controls a data driver 220 to provide a first data voltage H in a first subframe and a second data voltage L in a second subframe. In some exemplary implementations, the gamma voltage generator 250 outputs a first gamma reference voltage Vref1 and a second gamma reference voltage Vref2 which are different from each other. The first gamma reference voltage Vref1 is a reference voltage applied when pixel data DATA is digital-to-analog (D/A) converted into a first data voltage H. The second gamma reference voltage Vref2 is a reference voltage applied when the pixel data DATA is D/A converted into a second data voltage L. The gamma voltage generator 250 may temporally divide a unit frame into two data having different voltages by controlling the first data voltage H to be output in the first subframe and the second data voltage L to be output in the second subframe.

Other elements of the LCD 20 are substantially the same as those of the LCD 10 identified by the same names in FIGS. 1 through 8, and thus a description thereof will be omitted.

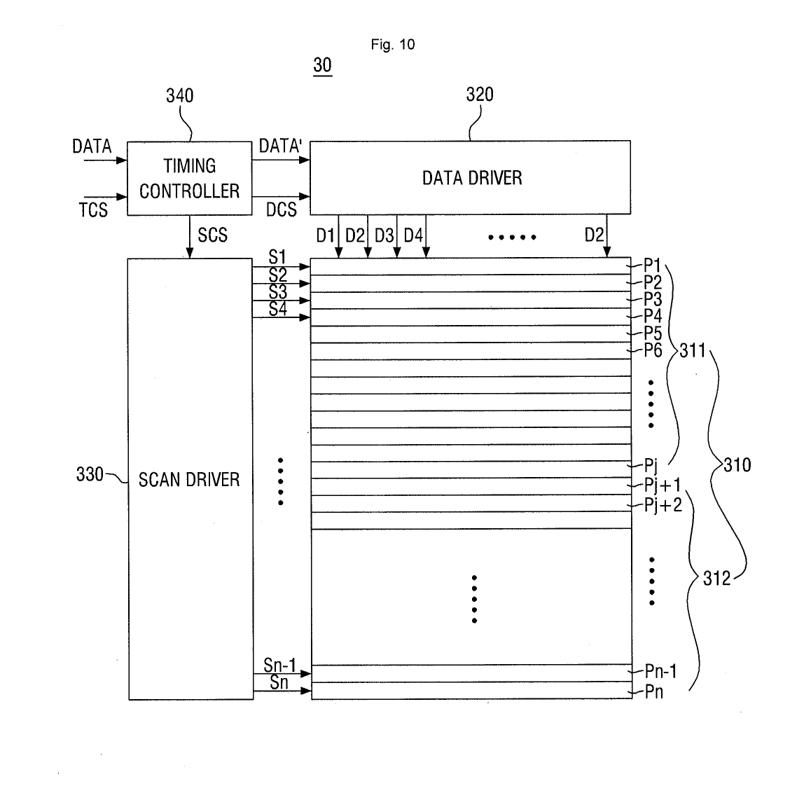

FIG. 10 is a block diagram of an LCD 30 according to another embodiment of the disclosed technology.

Referring to FIG. 10, the LCD 30 includes a display panel 310, a scan driver 330, and a data driver 320.

Various types of display panels can be used as the display panel 310 according to a method of displaying an image. In one exemplary implementation, the display panel 310 is, but is not limited to, one of an LCD panel, an organic light-emitting display panel, a plasma display panel, and an electrophoretic display panel. The display panel 310 may include a plurality of display surfaces P1 through Pn. The display surfaces P1 through Pn may not display independent images individually. Instead, the whole image displayed on the display panel 310 is divided according to the area of each of the display surfaces P1 through Pn. In some exemplary implementations, the display surfaces P1 through Pn individually receives independent scan signals S1 through Sn from the scan driver 330. Each of the display surfaces P1 through Pn may include a plurality of scan lines SL1 through SLn, a plurality of data lines DL1 through DLm intersecting the scan lines SL1 through SLn, and a plurality of pixels PX, each connected to one of the scan lines SL1 through SLn and one of the data lines DL1 through DLm.

The scan driver 330 may generate the scan signals S1 through Sn and provide the scan signals S1 through Sn to the display surfaces P1 through Pn, respectively. The scan driver 330 may transmit the scan signals S1 through Sn sequentially. In some exemplary implementations, the scan driver 330 transmits the first scan signal S1 to the first display surface P1 and then transmits the second scan signal S2 to the second display surface P2. The display surfaces P1 through Pn may receive data voltages D1 through Dm from the data driver 330 according to the scan signals S1 through Sn.

Each of the data voltages D1 through Dm may include a first data voltage H and a second data voltage L. The second data voltage L is different than the first data voltage H. In some exemplary implementations, the data driver 330 provides the first data voltage H and the second data voltage L to each of the pixels PX during a unit frame. An image to be displayed on the display panel 310 may be provided as a combination of the first data voltage H and the second data voltage L. The first data voltage H may be a high-luminance data voltage, and the second data voltage L may be a low-luminance data voltage. In one exemplary implementation, the first data voltage H has, but not limited to, a value equal to or greater than approximately 120% of a luminance level displayed on the display panel 310. The second data voltage L has, but not limited to, a value equal to or less than approximately 80% of the luminance level. Pixels having high luminance and pixels having low luminance can provide high viewing-angle characteristics and good lateral visibility. In some exemplary implementation, because the LCD 30 displays an image by applying the first data voltage H of high luminance and the second data voltage L of low luminance to the display panel 310 during a unit frame, it can provide improved the lateral visibility of the LCD 30.

Here, the first data voltage H may be provided to the display panel 310 during a first subframe SF1, and the second data voltage L may be provided to the display panel 310 during a second subframe SF2. The first subframe SF1 and the second subframe SF2 may be included in one unit frame F1. In some exemplary implementations, the first data voltage H and the second data voltage L are provided at different times. The first subframe SF1 is followed by the second subframe SF2. When the first subframe SF1 and the second subframe SF2 are provided for different periods of time, the viewing angle can be additionally improved. That is, a ratio of the period of the first subframe SF1 and the period of the second subframe SF2 may be greater or less than 1.

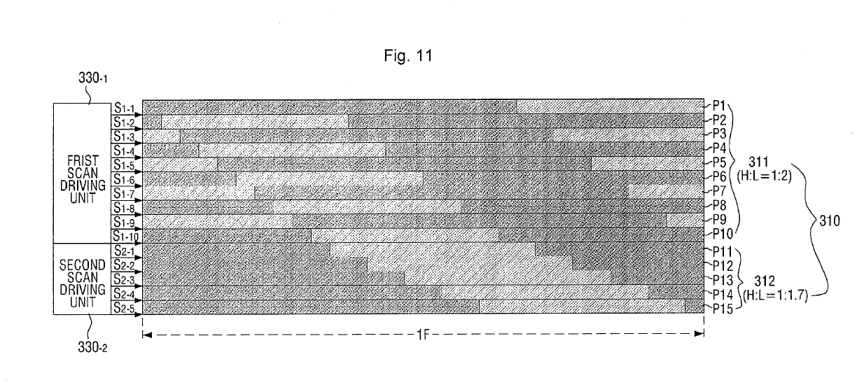

The ratio of a period of time during which the second data voltage L is provided to some (311) of the display surfaces P1 through Pn of the display panel 310 to a period of time during which the first data voltage H is provided to the display surfaces (311) may be about 2 to 2.5. The ratio of a period of time during which the second data voltage L is provided to the rest (312) of the display surfaces P1 through Pn of the display panel 310 to a period of time during which the first data voltage H is provided to the display surfaces (312) may be about 1.7 to 2.1. This will be described in greater detail with reference to FIGS. 11 through 14.

FIGS. 11 through 14 are diagrams illustrating the divided driving of the LCD 30.

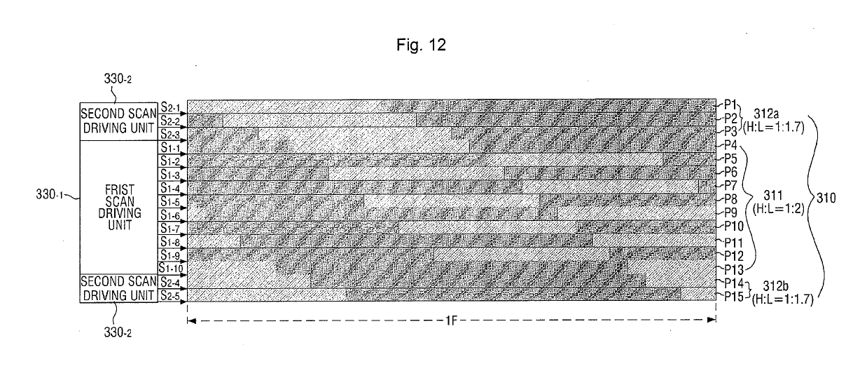

Referring to FIGS. 11 and 12, a first group display surface 311 occupies two thirds of the entire area of a plurality of display surfaces P1 through P15. A ratio of a period of time during which the second data voltage L is provided to the first group display surface 311 to a period of time during which the first data voltage H is provided to the first group display surface 311 may be 2. Here, the number of display surfaces and the number of signals provided are not limited to the numbers illustrated in FIGS. 11 and 12. In some exemplary implementation, a unit frame 1F includes a first subframe in which the first data voltage H is provided and a second subframe in which the second data voltage L is provided. a ratio of the period of the second subframe to the period of the first subframe may be about 2. A first scan driving unit 330_1 may transmit a plurality of scan signals S1_1 through S1_10 to the corresponding first group display surface 311. The scan signals S1_1 through S1_10 may be provided twice corresponding to the first subframe and the second subframe, and pixels PX of a display surface may receive the first data voltage H and the second data voltage L from the data driver 330 corresponding to the first subframe and the second subframe, respectively. Here, the scan signals S1_1 through S1_10 are provided not sequentially but individually. Therefore, successive scan signals (e.g., S1_1 and S1_2) have different scanning orders. In some exemplary implementaiton, after the second data voltage L is applied to pixels of the first display surface P1, the first data voltage H is applied to pixels of the second display surface P2 as illustrated in FIGS. 11 and 12. However, the disclosed technology is not limited thereto. The order in which the first data voltage H and the second data voltage L are applied and a ratio of a period of time during which the second data voltage L is applied to a period of time during which the first data voltage H is applied may be controlled by a timing controller 340.

The second group display surface 312 occupies one third of the entire area of the display surfaces P1 through P15. The ratio of a period of time during which the second data voltage L is provided to the second group display surface 312 to a period of time during which the first data voltage H is provided to the second group display surface 312 may be about 1.7. Here, a second scan driving unit 330_2 can drive the corresponding second group display surface 312 individually using a plurality of scan signals S2_1 through S2_5.

As illustrated in FIG. 11, the first group display surface 311 and the second group display surface 312 may be formed in upper and lower parts of the display panel 310, respectively. However, the disclosed technology is not limited thereto. As illustrated in FIG. 12, the first group display surface 311 is formed in the middle of the display panel 310. The second group display surface 312 is formed in the upper and lower parts of the first group display surface 311. The first group display surface 311 and the second group display surface 312 to which the first data voltage H and the second data voltage L are provided in the above ratios can improve viewing angle more effectively and provide improved lateral visibility. In addition, the first group display surface 311 and the second group display surface 312 can correct image data using different lookup tables in order to prevent a difference in front gamma and visibility between the display surfaces.

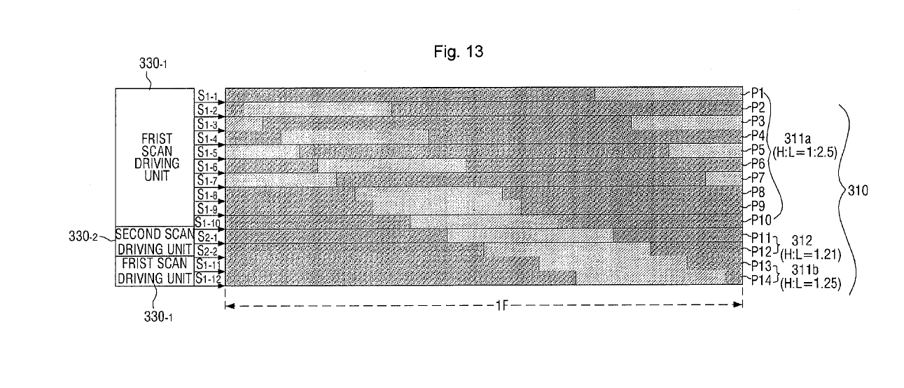

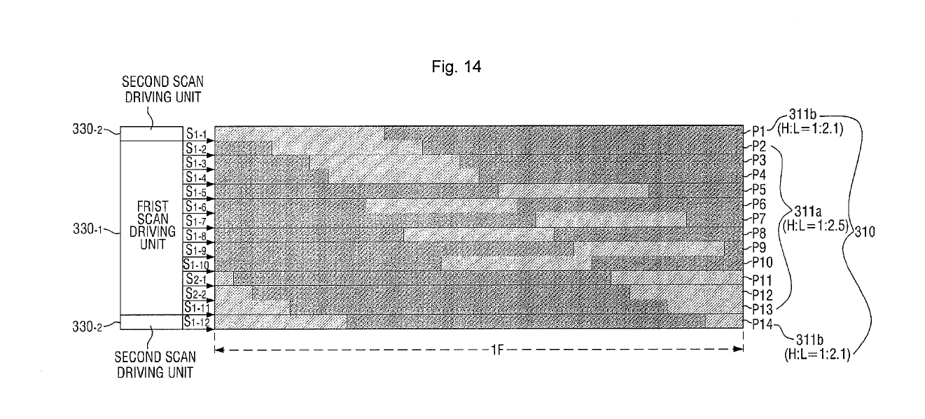

Referring to FIGS. 13 and 14, a first group display surface 311 occupies six sevenths of the entire area of a plurality of display surfaces P1 through P14. The ratio of a period of time during which the second data voltage L is provided to the first group display surface 311 to a period of time during which the first data voltage H is provided to the first group display surface 311 may be about 2.5. Here, the number of display surfaces and the number of signals provided are not limited to the numbers illustrated in FIGS. 13 and 14. In some exemplary implementations, a unit frame 1F includes a first subframe in which the first data voltage H is provided and a second subframe in which the second data voltage L is provided. The ratio of the period of the second subframe to the period of the first subframe may be about 2.5. A first scan driving unit 330_1 may transmit a plurality of scan signals S1_1 through S1_12 to the corresponding first group display surface 311. The scan signals S1_1 through S1_12 may be provided twice corresponding to the first subframe and the second subframe, and pixels PX of a display surface may receive the first data voltage H and the second data voltage L from the data driver 330 corresponding to the first subframe and the second subframe, respectively. Here, the scan signals S1_1 through S1_12 are provided not sequentially but individually. Therefore, successive scan signals (e.g., S1_1 and S1_2) have different scanning orders. In some exemplary implementations, after the second data voltage L is applied to pixels of the first display surface P1, the first data voltage H is applied to pixels of the second display surface P2 as illustrated in FIGS. 13 and 14. However, the disclosed technology is not limited thereto. The order in which the first data voltage H and the second data voltage L are applied and a ratio of a period of time during which the second data voltage L is applied to a period of time during which the first data voltage H is applied is controlled by the timing controller 340.

The second group display surface 312 occupies one seventh of the entire area of the display surfaces P1 through P14. The ratio of a period of time during which the second data voltage L is provided to the second group display surface 312 to a period of time during which the first data voltage H is provided to the second group display surface 312 may be about 2.1. Here, a second scan driving unit 330_2 can drive the corresponding second group display surface 312 individually using a plurality of scan signals S2_1 and S2_2.

As illustrated in FIG. 13, the second group display surface 312 may be disposed between parts of the first group display surface 311. However, the disclosed technology is not limited thereto. As illustrated in FIG. 14, the first group display surface 311 is disposed between parts of the second group display surface 312. The first group display surface 311 and the second group display surface 312 to which the first data voltage H and the second data voltage L are provided in the above ratios can improve viewing angle more effectively and provide improved lateral visibility. In addition, the first group display surface 311 and the second group display surface 312 can correct image data using different lookup tables in order to prevent a difference in front gamma and visibility between the display surfaces.

The LCD 30 according to the current embodiment applies the first data voltage H having high luminance and the second data voltage L having low luminance to a plurality of display surfaces in different ratios. Therefore, the LCD 30 according to the current embodiment can improve lateral visibility more effectively. Other elements of the LCD 30 are substantially the same as those of the LCD 10 identified by the same names in FIGS. 1 through 8, and thus a description thereof will be omitted.

Another embodiment of the disclosed technology will now be described.

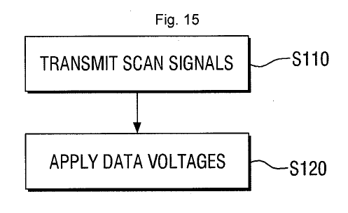

FIG. 15 is a flowchart illustrating a method of driving an LCD according to an embodiment of the disclosed technology.

In some embodiments, the FIG. 15 procedure is implemented in a conventional programming language, such as C or C++ or another suitable programming language. The program can be stored on a computer accessible storage medium of the LCD display, for example, a memory (not shown) of the LCD display or a data driver 120. In certain embodiments, the storage medium includes a random access memory (RAM), hard disks, floppy disks, digital video devices, compact discs, video discs, and/or other optical storage mediums, etc. The program may be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states may be added, others removed, or the order of the states changed in FIG. 15.

Referring to FIG. 15, the method of driving an LCD according to the current embodiment includes transmitting scan signals (operation S11) and applying data voltages (operation S120). A more specific description will be given below with reference to FIGS. 1 and 2 as well.

First, scan signals are transmitted to a display panel 110 (operation S110).

Various types of display panels can be used as the display panel 110 according to a method of displaying an image. In one exemplary implementation, the display panel 110 is, but is not limited to, one of an LCD panel, an organic light-emitting display panel, a plasma display panel, and an electrophoretic display panel. The display panel 110 may include a plurality of display surfaces P1 through Pn. The display surfaces P1 through Pn may not display independent images individually. Instead, the whole image displayed on the display panel 110 may be divided according to the area of each of the display surfaces P1 through Pn. However, the display surfaces P1 through Pn may individually receive independent scan signals S1 through Sn from a scan driver 130. Each of the display surfaces P1 through Pn may include a plurality of scan lines SL1 through SLn, a plurality of data lines DL1 through DLm intersecting the scan lines SL1 through SLn, and a plurality of pixels PX, each connected to one of the scan lines SL1 through SLn and one of the data lines DL1 through DLm.

The scan driver 130 generates the scan signals S1 through Sn. The scan driver 130 may provide the scan signals S1 through Sn to the display surfaces P1 through Pn, respectively. The scan driver 130 may sequentially transmit the scan signals S1 through Sn. In some exemplary implementation, the scan driver 130 transmits the first scan signal S1 to the first display surface P1 and then transmits the second scan signal S2 to the second display surface P2. The display surfaces P1 through Pn receives data voltages D1 through Dm from a data driver 120 according to the scan signals S1 through Sn.

Next, data voltages are received (operation S130).

The data driver 120 may receive corrected image data DATA′ and a data driver control signal DCS from a timing controller 140. In addition, the data driver 120 may receive gamma voltages from a gamma voltage generator (not shown). The data driver 120 may convert the corrected image data DATA′ in a digital form into the data voltages D1 through Dm in an analog form by using the gamma voltages. In some exemplary implementations, the data driver 120 converts the corrected image data DATA′ into the data voltages D1 through Dm by using, e.g., linear interpolation. The data driver 120 may include a buffer, and the data voltages D1 through Dm may be applied to the buffer. The buffer may buffer the data voltages D1 through Dm and output the data voltages D1 through Dm to the data lines DL1 through DLm.

Each of the data voltages D1 through Dm may include a first data voltage H and a second data voltage L. The second data voltage L is different than the first data voltage H. In some exemplary implementation, the data driver 120 provides the first data voltage H and the second data voltage L to each of the pixels PX during a unit frame. An image to be displayed on the display panel 110 is provided as a combination of the first data voltage H and the second data voltage L. The first data voltage H may be a high-luminance data voltage, and the second data voltage L may be a low-luminance data voltage. In one exemplary implementation, the first data voltage H has, but not limited to, a value equal to or greater than approximately 120% of a luminance level displayed on the display panel 110. The second data voltage L has, but not limited to, a value equal to or less than approximately 80% of the luminance level. Pixels having high luminance and pixels having low luminance can provide high viewing-angle characteristics and good lateral visibility. In some exemplary implementations of the method of driving an LCD, the first data voltage H having high luminance and the second data voltage L having low luminance are applied to the display panel 110 during a unit frame, thereby providing improved lateral visibility of the LCD. The first data voltage H may be provided to the display panel 110 during a first subframe SF1, and the second data voltage L may be provided to the display panel 110 during a second subframe SF2. The first subframe SF1 and the second subframe SF2 may be included in one unit frame F1. In some exemplary implementations, the first data voltage H and the second data voltage L are provided at different times. The first subframe SF1 is followed by the second subframe SF2. When the first subframe SF1 and the second subframe SF2 are provided for different periods of time, the viewing angle can be additionally improved. Therefore, the ratio of the period of the first subframe SF1 and the period of the second subframe SF2 may be greater or less than 1.

To divide a unit frame into a plurality of subframes as described above, the display panel 110 may need to be driven at a high-speed frequency. However, in the method of driving an LCD according to the current embodiment, the same effect of driving the display panel 110 at a high-speed frequency can be obtained by dividing the display panel 110 into a plurality of display surfaces and driving the display surfaces individually at about 120 Hz or 60 Hz, not at a high-speed frequency. That is, when the display panel 110 is divided into first through n^{th} display surfaces, a ratio of the period of the second subframe SF2 to the period of the first subframe SF1 may be about 2n−1, where n is an integer greater than one. In one exemplary implementation of the method of driving an LCD, the display panel 110 is divided into two display surfaces and driven separately. Therefore, four separate subframes are provided even at a driving frequency of about 60 Hz, and a high-luminance voltage and a low-luminance voltage may be provided in a time ratio of about 1:3. As a result, not only lateral visibility can be improved, but also power loss can be reduced. In another exemplary implementation, the display panel 110 is divided into three display surfaces and driven separately. Therefore, six separate subframes are provided even at a driving frequency of about 60 Hz. A high-luminance voltage and a low-luminance voltage are provided in a time ratio of about 1:5. As a result, not only lateral visibility can be improved, but also power loss can be reduced.

In some embodiments, the applying of the data voltages (operation S120) further includes correcting image data (operation S115). In the correcting of the image data (operation S115), a data generator 141 of the timing controller 141 may correct image data DATA to produce the corrected image data DATA′ before the image data DATA is output to the data driver 120. The data generator 141 may correct the image data DATA such that the image data DATA corresponds to a first subframe and a second subframe. That is, the image data DATA can be corrected such that the first data voltage H is applied during the first subframe and that the second data voltage L is applied during the second subframe. Data needed for correcting the image data DATA may be read out from a lookup table stored in a memory 144, but the disclosed technology is not limited thereto.

In some embodiments, the applying of the data voltages (operation S120) further includes providing gamma voltages (operation S125). In the providing of the gamma voltages (operation S125), the image data DATA may be D/A converted using a first gamma reference voltage Vref1 and a second gamma reference voltage Vref2 which are different from each other and provided by the gamma voltage generator. If the providing of the gamma voltages (operation S125) is performed, the correcting of the image data (operation S115) may not be performed. The first gamma reference voltage Vref1 may be a reference voltage applied when the image data DATA is D/A converted into the first data voltage H. The second gamma reference voltage Vref2 may be a reference voltage applied when the image data DATA is D/A converted into the second data voltage L. The gamma voltage generator may temporally divide a unit frame into two data having different voltages by controlling the first data voltage H to be output in the first subframe and the second data voltage L to be output in the second subframe.

Other elements used in the method of driving an LCD according to the current embodiment are substantially the same as those of the LCD 10 identified by the same names in FIGS. 1 through 8, and thus a description thereof will be omitted.

Embodiments of the disclosed technology provide at least one of the following advantages.

It is possible to improve lateral visibility of an LCD without driving the LCD at a high frequency.

In addition, it is possible to reduce power consumption due to high-frequency driving.

However, the effects of the disclosed technology are not restricted to the one set forth herein. The above and other effects of the disclosed technology will become more apparent to one of daily skill in the art to which the disclosed technology pertains by referencing the claims.

While the disclosed technology has been particularly shown and described with reference to exemplary embodiments thereof, it will be understood by those of ordinary skill in the art that various changes in form and detail may be made therein without departing from the spirit and scope of the disclosed technology as defined by the following claims. The exemplary embodiments should be considered in a descriptive sense only and not for purposes of limitation.

What is claimed is:

1. A liquid crystal display (LCD) comprising:
a display panel including a plurality of display surfaces;
a scan driver configured to provide a scan signal to each of the display surfaces; and
a data driver configured to provide a first data voltage and a second data voltage to the display panel during a unit frame, wherein the second data voltage is different than the first data voltage,
wherein the unit frame comprises a first subframe during which the first data voltage is provided and a second subframe during which the second data voltage is provided, and wherein the ratio of the period of the first subframe to the period of the second subframe is greater or less than 1.

2. The LCD of claim 1, wherein the display panel further comprises first through n-th display surfaces, wherein the scan driver further comprises first through n-th scan driving units configured to sequentially transmit the scan signals to the first through n-th display surfaces, respectively, wherein the ratio of the period of the second subframe to the period of the first subframe is 2n−1, and wherein where n is an integer greater than one.

3. The LCD of claim 2, wherein each of the display surfaces comprises a plurality of scan lines, a plurality of data lines intersecting the scan lines, and a plurality of pixels, wherein each pixel is connected to one of the scan lines and one of the data lines, and wherein the first through n-th scan driving units transmit the scan signals to the scan lines, respectively.

4. The LCD of claim 1, wherein the display panel is configured to display an image as a combination of the first data voltage and the second data voltage.

5. The LCD of claim 4, wherein the first data voltage has a value substantially equal to or greater than approximately 120% of a luminance level displayed on the display panel, and wherein the second data voltage has a value equal to or less than approximately 80% of the luminance level.

6. The LCD of claim 1, further comprising a data generator configured to correct received image data such that the image data corresponds to the period of the first subframe and the period of the second subframe.

7. The LCD of claim 1, further comprising a gamma voltage generator configured to generate different gamma reference voltages.

8. The LCD of claim 1, wherein the refresh frequency of the unit frame is about 60 Hz.

9. The LCD of claim 1, wherein the display panel comprises a first display surface and a second display surface, wherein the scan driver comprises a first scan driving unit and a second scan driving unit, wherein the first and second scan driving units are configured to transmit the scan signals to the first display surface and the second display surface, respectively, and wherein a ratio of the period of the second subframe to the period of the first subframe is three.

10. The LCD of claim 9, wherein each of the first display surface and the second display surface independently configured to receive the first data voltage and the second data voltage in a time ratio of about 1:3.

11. An LCD comprising:
a display panel including a plurality of display surfaces;
a scan driver configured to provide a scan signal to each of the display surfaces; and
a data driver configured to sequentially provide a first data voltage and a second data voltage to the display panel during a unit frame, wherein the second data voltage is different than the first data voltage
wherein a period of time during which the second data voltage is provided to some of the display surfaces of the display panel to a period of time during which the first data voltage is provided to the some of the display surfaces is about 2 to 2.5, and wherein a period of time during which the second data voltage is provided to the other display surfaces of the display panel to a period of time during which the first data voltage is provided to the other display surfaces is about 1.7 to 2.1.

12. The LCD of claim 11, wherein a ratio of a period of time during which the second data voltage is provided to six sevenths of the entire area of the display surfaces to a period of time during which the first data voltage is provided to the six sevenths of the entire area is 2.5, and wherein a ratio of a period of time during which the second data voltage is provided to one sevenths of the entire area of the display surfaces to a period of time during which the first data voltage is provided to the one sevenths of the entire area is about 2.1.

13. The LCD of claim 11, wherein a ratio of a period of time during which the second data voltage is provided to two thirds of the entire area of the display surfaces to a period of time during which the first data voltage is provided to the two thirds of the entire area is 2, and wherein a ratio of a period of time during which the second data voltage is provided to one third of the entire area of the display surfaces to a period of time during which the first data voltage is provided to the one third of the entire area is about 1.7.

14. The LCD of claim 11, wherein the display panel displays an image to be displayed on as a combination of the first data voltage and the second data voltage.

15. The LCD of claim 14, wherein the first data voltage has a value equal to or greater than approximately 120% of a luminance level displayed on the display panel, and wherein the second data voltage has a value equal to or less than approximately 80% of the luminance level.

16. A method of driving an LCD, the method comprising:
transmitting a scan signal to each of a plurality of display surfaces of a display panel; and
transmitting a data voltage according to the scan signal,
wherein a first data voltage and a second data voltage included in the data voltage are applied sequentially during a unit frame, wherein the unit frame comprises a first subframe during which the first data voltage is provided and a second subframe during which the second data voltage is provided, and wherein a ratio of a period of the first subframe to a period of the second subframe is greater or less than 1.

17. The method of claim 16, wherein the display panel comprises first through n-th display surfaces, wherein a scan driver comprises first through n-th scan driving units configured to sequentially transmit the scan signals to the first through n-th display surfaces, respectively, wherein a ratio of the period of the second subframe to the period of the first subframe is 2n−1, and where n is an integer greater than one.

18. The method of claim 17, wherein each of the display surfaces comprises a plurality of scan lines, a plurality of data lines intersecting the scan lines, and a plurality of pixels, wherein each pixel is connected to one of the scan lines and one of the data lines, and wherein the first through n-th scan driving units transmit the scan signals to the scan lines, respectively.

19. The method of claim 16, wherein the display panel displays an image as a combination of the first data voltage and the second data voltage.

20. The method of claim 19, wherein the first data voltage has a value equal to or greater than approximately 120% of a luminance level displayed on the display panel, and wherein the second data voltage has a value equal to or less than approximately 80% of the luminance level.
